(19) United States
(12) Patent Application Publication
(10) Pub. No.: US 2020/0384992 A1
(43) Pub. Date: Dec. 10, 2020

(54) VEHICLE CONTROL APPARATUS, VEHICLE, OPERATION METHOD OF VEHICLE CONTROL APPARATUS, AND NON-TRANSITORY COMPUTER-READABLE STORAGE MEDIUM

(71) Applicant: HONDA MOTOR CO., LTD., Tokyo (JP)

(72) Inventor: Atsuhiro EGUCHI, Wako-shi (JP)

(21) Appl. No.: 16/891,277

(22) Filed: Jun. 3, 2020

(30) Foreign Application Priority Data
Jun. 6, 2019 (JP) 2019-106477

(51) Int. Cl. B60W 30/12; G06K 9/00; B60W 40/072

(52) U.S. Cl. CPC B60W 30/12; G06K 9/00798; B60W 40/072; B60W 2552/10; B60W 2552/53; B60W 2420/42; B60W 2552/30

(57) ABSTRACT

A vehicle control apparatus that controls a vehicle, comprising a controller configured to execute, based on a determination position in a direction of travel of the vehicle, lane departure suppression control to suppress the vehicle from departing from at least one of a division line and a road boundary, wherein in a case in which the shape of the road in the direction of travel of the vehicle is not a curve, the controller executes the lane departure suppression control based on a first determination position in the direction of travel of the vehicle, and in a case in which the shape of the road in the direction of travel of the vehicle is the curve, the controller executes the lane departure suppression control based on a second determination position closer to the vehicle than the first determination position.

### CROSS-REFERENCE TO RELATED APPLICATION

This application claims priority to and the benefit of Japanese Patent Application No. 2019-106477 filed on Jun. 6, 2019, the entire disclosure of which is incorporated herein by reference.

### BACKGROUND OF THE INVENTION

### Field of the Invention

The present invention relates to a vehicle control apparatus, a vehicle, an operation method of the vehicle control apparatus, and a non-transitory computer-readable storage medium.

### Description of the Related Art

Conventionally, there is known a lane departure prevention technique as an example of support for an occupant of a vehicle. Japanese Patent Laid-Open No. 2017-13559 discloses that a control start condition or a control end condition is set more strictly as the curvature of a curve increases.

However, although Japanese Patent Laid-Open No. 2017-13559 discloses control related to steering when a vehicle is traveling on a curve, the degradation of the recognition accuracy of the vehicle in the direction of travel is not considered, and lane departure suppression control with respect to the lane is executed erroneously or not executed at all. That is, it is problematically difficult to execute lane departure suppression control suitable for the shape of the road.

The present invention provides a technique for implementing lane departure suppression control suitable for the shape of a road.

### SUMMARY OF THE INVENTION

According to one aspect of the present invention, there is provided a vehicle control apparatus that controls a vehicle, comprising: a detector configured to detect at least one of a division line and a road boundary of a road; a shape detector configured to detect a shape of the road; and a controller configured to execute, based on a determination position in a direction of travel of the vehicle, lane departure suppression control to suppress the vehicle from departing from at least one of the division line and the road boundary, wherein in a case in which the shape of the road in the direction of travel of the vehicle is not a curve, the controller executes the lane departure suppression control based on a first determination position in the direction of travel of the vehicle, and in a case in which the shape of the road in the direction of travel of the vehicle is the curve, the controller executes the lane departure suppression control based on a second determination position closer to the vehicle than the first determination position.

### BRIEF DESCRIPTION OF THE DRAWINGS

The accompanying drawings, which are incorporated in and constitute a part of the specification, illustrate embodiments of the invention and, together with the description, serve to explain the invention.

FIG. 1 is a block diagram of a vehicle control apparatus according to an embodiment;

FIG. 2 is an explanatory view of the positional relationship between division lines, road boundaries, and a vehicle according to the embodiment;

FIG. 3 is an enlarged view of the periphery of the vehicle, the division line, and the road boundary;

FIG. 4 is a graph showing an example of the relationship between a curvature of the road and a distance from the vehicle to a determination position according to the embodiment;

FIG. 5 is a flowchart showing the procedure of processing executed by the vehicle control apparatus according to the embodiment; and

FIG. 6 is a graph showing an example of the relationship between the curvature of the road and the distance from the vehicle to the determination position according to the embodiment.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

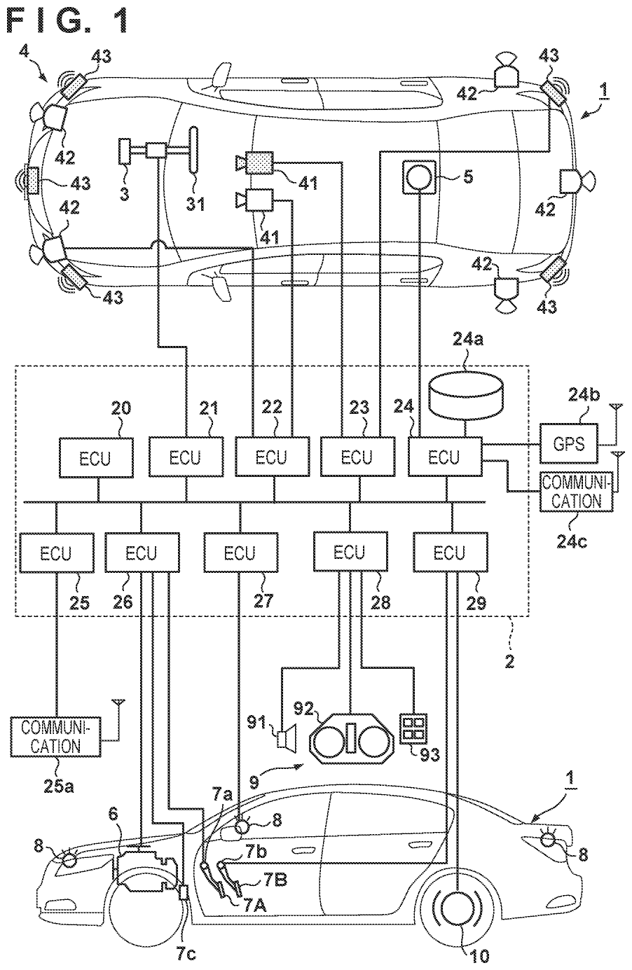

FIG. 1 is a block diagram of a vehicle control apparatus according to an embodiment of the present invention and controls a vehicle 1. FIG. 1 shows the outline of the vehicle 1 by a plan view and a side view. The vehicle 1 is, for example, a sedan-type four-wheeled vehicle.

A procedure of processing performed by an ECU 20 according to this embodiment shown in FIG. 1 will be described. The vehicle control apparatus includes a control unit (controller) 2. The control unit 2 includes a plurality of ECUs 20 to 29 communicably connected by an in-vehicle network. Each ECU includes a processor represented by a CPU (Central Processing Unit), a storage device such as a semiconductor memory, an interface with an external device, and the like. The storage device stores programs to be executed by the processor, data to be used by the processor for processing, and the like. Each ECU may include a plurality of processors, storage devices, and interfaces.

The functions and the like provided by the ECUs 20 to 29 will be described below. Note that the number of ECUs and the provided functions can be appropriately designed in the vehicle 1, and they can be subdivided or integrated as compared to this embodiment.

The ECU 20 executes control associated with automated driving of the vehicle 1. In automated driving, at least one of steering and acceleration/deceleration of the vehicle 1 is automatically controlled. The ECU 20 can also execute control related to driving support of the vehicle 1. Driving support includes, for example, adaptive cruise control (ACC) for reducing the driving load of a driver by executing travel by following a preceding vehicle by maintaining an appropriate following distance, and lane departure suppression control for suppress departure from a lane (division line). Automatic control of acceleration/deceleration is mainly performed in adaptive cruise control (ACC), and automatic control of the steering operation is mainly performed in lane departure suppression control.

The ECU 21 controls an electric power steering device 3. The electric power steering device 3 includes a mechanism that steers front wheels in accordance with a driving operation (steering operation) of a driver on a steering wheel 31. In addition, the electric power steering device 3 includes a motor that generates a driving force to assist the steering operation or automatically steer the front wheels, and a sensor that detects the steering angle. If the driving state of the vehicle 1 is automated driving or driving support, the ECU 21 automatically controls the electric power steering device 3 in correspondence with an instruction from the ECU 20 and controls the direction of travel of the vehicle 1.

The ECUs 22 and 23 perform control of detection units (detector) 41 to 43 that detect the peripheral state of the vehicle and information processing of detection results. Each detection unit 41 is a camera (to be sometimes referred to as the camera 41 hereinafter) that captures the front side of the vehicle 1. In this embodiment, the cameras 41 are attached to the windshield inside the vehicle cabin at the roof front of the vehicle 1. When images captured by the cameras 41 are analyzed, the contour of a target or a division line (a white line or the like) of a lane on a road can be extracted.

The detection unit 42 is Light Detection and Ranging (LIDAR) (to be sometimes referred to as the LIDAR 42 hereinafter), and detects a target around the vehicle 1 or measures the distance to a target. In this embodiment, five LIDARs 42 are provided; one at each corner of the front portion of the vehicle 1, one at the center of the rear portion, and one on each side of the rear portion. The detection unit 43 is a millimeter wave radar (to be sometimes referred to as the radar 43 hereinafter), and detects a target around the vehicle 1 or measures the distance to a target. In this embodiment, five radars 43 are provided; one at the center of the front portion of the vehicle 1, one at each corner of the front portion, and one at each corner of the rear portion.

The ECU 22 performs control of one camera 41 and each LIDAR 42 and information processing of detection results. The ECU 23 performs control of the other camera 41 and each radar 43 and information processing of detection results. Since two sets of devices that detect the peripheral state of the vehicle are provided, the reliability of detection results can be improved. In addition, since detection units of different types such as cameras, LIDARs, and radars are provided, the peripheral environment of the vehicle can be analyzed multilaterally.

The ECU 24 performs control of a gyro sensor 5, a GPS sensor 24b, and a communication device 24c and information processing of detection results or communication results. The gyro sensor 5 detects a rotary motion of the vehicle 1. The course of the vehicle 1 can be determined based on the detection result of the gyro sensor 5, the wheel speed, or the like. The GPS sensor 24b detects the current position of the vehicle 1. The communication device 24c performs wireless communication with a server that provides map information and traffic information and acquires these pieces of information. The ECU 24 can access a map information database 24a formed in the storage device. The ECU 24 searches for a route from the current position to the destination.

The ECU 25 includes a communication device 25a for inter-vehicle communication. The communication device 25a performs wireless communication with another vehicle on the periphery and performs information exchange between the vehicles.

The ECU 26 controls a power plant 6. The power plant 6 is a mechanism that outputs a driving force to rotate the driving wheels of the vehicle 1 and includes, for example, an engine and a transmission. The ECU 26, for example, controls the output of the engine in correspondence with a driving operation (accelerator operation or acceleration operation) of the driver detected by an operation detection sensor 7a provided on an accelerator pedal 7A, or switches the gear ratio of the transmission based on information such as a vehicle speed detected by a vehicle speed sensor 7c. If the driving state of the vehicle 1 is automated driving, the ECU 26 automatically controls the power plant 6 in correspondence with an instruction from the ECU 20 and controls the acceleration/deceleration of the vehicle 1.

The ECU 27 controls lighting devices (headlights, taillights, and the like) including direction indicators 8 (turn signals). In the example shown in FIG. 1, the direction indicators 8 are provided in the front portion, door mirrors, and the rear portion of the vehicle 1.

The ECU 28 controls an input/output device 9. The input/output device 9 outputs information to the driver and accepts input of information from the driver. A voice output device 91 notifies the driver of the information by voice. A display device 92 notifies the driver of information by displaying an image. The display device 92 is arranged, for example, in front of the driver's seat and constitutes an instrument panel or the like. Note that although a voice and display have been exemplified here, the driver may be notified of information using a vibration or light. Alternatively, the driver may be notified of information by a combination of some of the voice, display, vibration, and light. Furthermore, the combination or the notification form may be changed in accordance with the level (for example, the degree of urgency) of information of which the driver is to be notified.

An input device 93 is a switch group that is arranged at a position where the driver can perform an operation, is used to issue an instruction to the vehicle 1, and may also include a voice input device.

The ECU 29 controls a brake device 10 and a parking brake (not shown). The brake device 10 is, for example, a disc brake device which is provided for each wheel of the vehicle 1 and decelerates or stops the vehicle 1 by applying a resistance to the rotation of the wheel. The ECU 29, for example, controls the operation of the brake device 10 in correspondence with a driving operation (brake operation) of the driver detected by an operation detection sensor 7b provided on a brake pedal 7B. If the driving state of the vehicle 1 is automated driving or driving support, the ECU 29 automatically controls the brake device 10 in correspondence with an instruction from the ECU 20 and controls deceleration and stop of the vehicle 1. The brake device 10 or the parking brake can also be operated to maintain the stop state of the vehicle 1. In addition, if the transmission of the power plant 6 includes a parking lock mechanism, it can be operated to maintain the stop state of the vehicle 1.

### Control Examples

Control of the vehicle 1 executed by the ECU 20 will be described next. The ECU 20 obtains, from the ECUs 22 and 23, information related to the peripheral state (for example, the division lines of the road, the road boundaries, oncoming vehicles, targets, and the like) of the vehicle 1, and issues instructions to the ECUs 21, 26, and 29 based on the obtained information to control the steering and deceleration/acceleration of the vehicle 1. For example, the ECU 20 executes lane departure suppression control to suppress the vehicle 1 from departing from a division line or a road boundary.

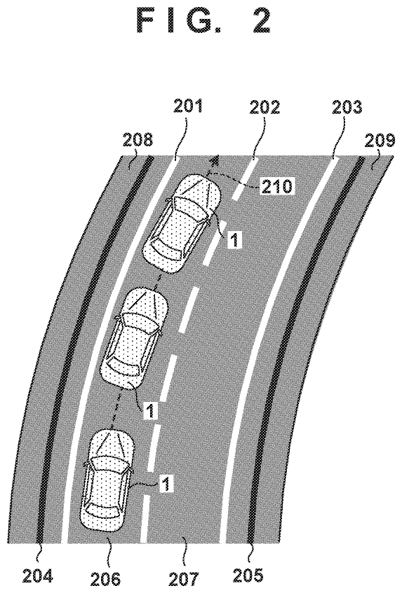

FIG. 2 is an explanatory view of lane departure suppression control of the vehicle 1 according to the embodiment. In FIG. 2, reference numeral 201 denotes a first division line; 202, a second division line (center line); and 203, a third division line. Reference numerals 204 and 205 denote road boundaries. The road boundaries 204 and 205 may be formed by three-dimensional objects (for example, guardrails or curbstones) present above a position higher than a road. Alternatively, they may not always be three-dimensional objects, but may be boundaries at the same height as that of the road. Reference numeral 206 denotes a travel lane of the vehicle 1 defined by the first division line 201 and the second division line 202. Reference numeral 207 denotes a travel lane (oncoming lane) defined by the second division line 202 and the third division line 203. Reference numerals 208 and 209 each denote a sidewalk. The vehicle 1 travels on the travel lane 206 along an arrow 210.

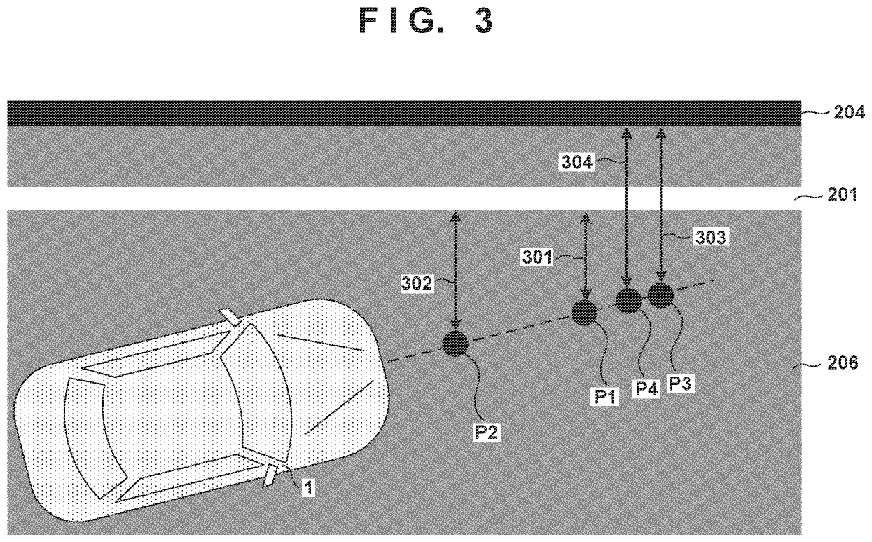

FIG. 3 is an enlarged view of the periphery of the vehicle 1, the first division line 201, and the road boundary 204. In FIG. 3, reference symbol P1 denotes a determination position of the lane departure suppression control with respect to the first division line 201 in a case in which the shape of the road is not a curve. Reference symbol P2 is a determination position of the lane departure suppression control with respect to the first division line 201 in a case in which the shape of the road is a curve. Although both of the determination position P1 and the determination position P2 are positions in the direction of travel of the vehicle 1, the determination position P2 is set at a position closer to the vehicle 1 than the determination position P1. Reference symbol P3 is a determination position of the lane departure suppression control with respect to the road boundary 204. In the description of this embodiment, assume that a distance from the vehicle 1 to the determination position of the lane departure suppression control with respect to the road boundary 204 is fixed (that is, is always at the position of the determination position P3) regardless of the shape of the road.

However, the determination position of the lane departure suppression control with respect to the road boundary 204 may be changed in accordance with whether the shape of the road with respect to the road boundary 204 is a curve. For example, in a case in which the shape of the road is a curve, the determination position can be set at a determination position P4 shown in FIG. 3, and in a case in which the shape of the road is not a curve, the determination position can be set at the determination position P3. In this case, the determination position P4 is a position farther way from the vehicle 1 than the determination position P1.

Reference numeral 301 denotes a distance from the first division line 201 to the determination position P1 of the vehicle 1; 302, a distance from the first division line 201 to the determination position P2 of the vehicle 1; and 303, a distance from the road boundary 204 to the determination position P3 of the vehicle 1. Reference numeral 304 denotes a distance from the road boundary 204 to the determination position P4 of the vehicle 1.

The lane departure suppression control with respect to the first division line 201 is executed based on the distance from the first division line 201 to a determination position (the determination position P1 or the determination position P2) of the vehicle 1. Each of the determination position P1 and the determination position P2 with respect to the first division line 201 is a reference position for determining a lateral distance which is the distance in a road width direction with respect to the first division line 201. For example, the lane departure suppression control will be executed in a case in which the distance from the first division line 201 to the determination position of the vehicle 1 (the determination position P1 or the determination position P2) is equal to or less than a threshold.

The lane departure suppression control with respect to the road boundary 204 is executed based on the distance from the road boundary 204 to the determination position P3 of the vehicle 1. The determination position P3 of the lane departure suppression control with respect to the road boundary 204 is a reference position for determining a lateral distance which is a distance in the road width direction with respect to the road boundary 204. For example, the lane departure suppression control will be executed in a case in which the distance from the road boundary 204 to the determination position P3 of the vehicle 1 is equal to or less than a threshold.

That is, in a case in which the shape of the road in the direction of travel of the vehicle 1 is not a curve, the lane departure suppression control with respect to the first division line 201 will be performed based on the determination position P1 in the direction of travel of the vehicle 1. In a case in which the shape of the road in the direction of travel of the vehicle 1 is a curve, the lane departure suppression control with respect to the first division line 201 will be performed based on the determination position P2 which is closer to the vehicle 1 than the determination position P1. Note that the ECU 20 can calculate the curvature of the road to determine whether the shape of the road is a curve. It can be determined that the shape of the road is not a curve when the value of the curvature is equal to or less than a threshold, and that the shape of the road is a curve when the value of the curvature more than the threshold.

In addition, regardless of whether the shape of the road is a curve, the lane departure suppression control with respect to the road boundary 204 will be executed based on the fixed determination position P3.

Note that although an example in which the determination position P2 is set when the shape of the road is a curve has been described in FIG. 3, the determination position P2 need not always be at a fixed position which is closer to the vehicle 1 than the determination position P1. For example, the position of the determination position P2 may be changed in proportion to the curvature of the road.

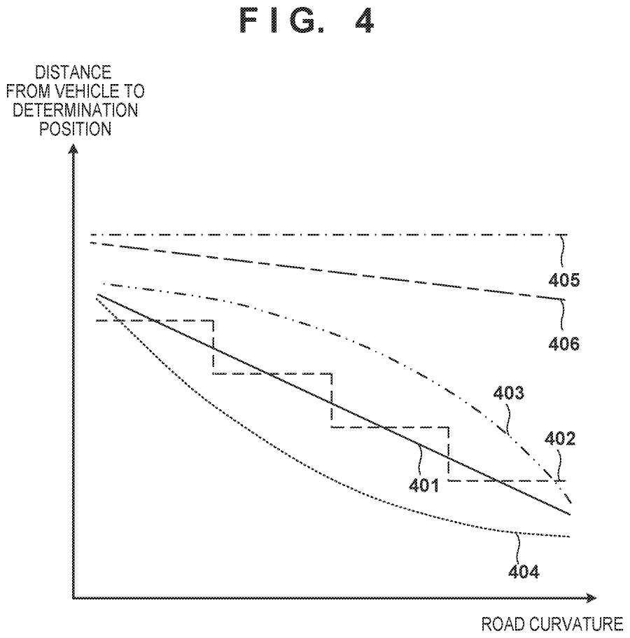

FIG. 4 is a graph showing an example of a method of determining the determination position corresponding to the curvature of the curve of the road. Reference numeral 401 denotes a graph representing that the determination position is set to a position closer to the vehicle 1 as the curvature of the road increases, that is, as the steepness of the curve increases, and that the determination position is set to a position farther away from the vehicle as the curvature of the road decreases, that is, as the steepness of the curve decreases (as closer the road is to a straight road).

Although, the determination position is changed linearly in accordance with the curvature of the road in the graph 401, the determination position need not always be changed linearly. For example, the determination position may be changed stepwise in the manner of a graph 402 which represents that the determination position can be changed stepwise for each predetermined curvature range. As another example, the determination position may be changed curvilinearly in accordance with the curvature as in the manner of a graph 403 and a graph 404. It is sufficient as long as a relationship in which the determination position becomes closer to the vehicle 1 as the curvature increases and the determination position becomes farther from the vehicle as the curvature decreases is set. As a result, control which is more suitable for the shape of the road can be performed.

In this case, reference numeral 405 denotes a graph representing the determination position for the lane departure suppression control with respect to the road boundary 204. Since the determination position (the determination position P3) with respect to the road boundary 204 is a fixed position which is apart from the vehicle 1 by a predetermined distance, the position does not change in accordance with the curvature.

However, if the determination position of the lane departure suppression control with respect to the road boundary 204 is set to be changeable instead of being set as a fixed position, the determination position may be changed in accordance with the curvature of the road. In this case, reference numeral 406 denotes a graph representing the determination position for lane departure suppression control with respect to the road boundary 204. The determination position is set to be at a position closer to the vehicle 1 as the curvature of the road increases. As a result, control which is more suitable for the shape of the road can be performed.

<Processing>

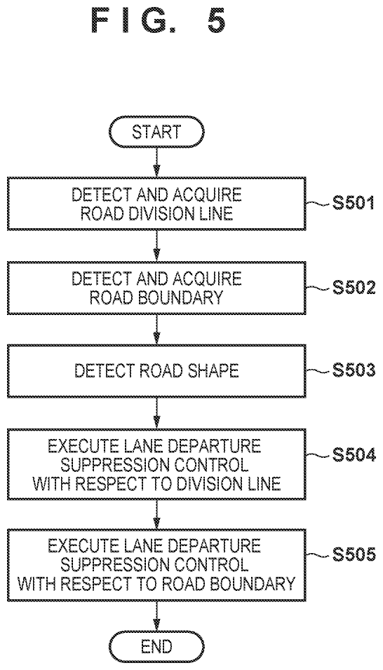

The procedure of processing executed by the vehicle control apparatus according to this embodiment will be described next with reference to the flowchart of FIG. 5.

In step S501, based on information related to the peripheral state of the vehicle 1 obtained from the ECUs 22 and 23, the ECU 20 detects a division line of the road. In step S502, based on the information related to the peripheral state of the vehicle 1 obtained from the ECUs 22 and 23, the ECU 20 detects a road boundary. In step S503, based on the information of the division line obtained in step S501 or the information of the road boundary detected in step S502, the ECU 20 detects the shape of the road. Alternatively, the shape of the road may be detected based on the map information which has been held in advance. In this case, for example, the shape of the road can be detected by obtaining the information of the shape of the road of a position corresponding to the current position of the vehicle 1.

In step S504, the ECU 20 executes, based on the shape of the road, the lane departure suppression control for suppressing the departure of the self-vehicle from the division line detected in step S501. More specifically, in a case in which the shape of the road in the direction of travel of the vehicle 1 is not a curve, the ECU 20 will execute the lane departure suppression control based on a first determination position (for example, the determination position P1) in the direction of travel of the vehicle 1. In a case in which the shape of the road in the direction of travel of the vehicle 1 is a curve, the lane departure suppression control will be executed based on a second determination position (for example, the determination position P2) which is closer to the vehicle 1 than the first determination position. Note that in the process of this step, the second determination position (for example, the determination position P2) may be set at a position closer to the vehicle 1 as the curvature of the curve of the road increases, as shown in each of the graphs 401 to 404 of FIG. 4.

In step S505, the ECU 20 executes the lane departure suppression control for suppressing the self-vehicle from departing from the road boundary detected in step S502. More specifically, the ECU 20 performs control to execute the lane departure suppression control with respect to the road boundary based on a fixed determination position (for example, the determination position P3) regardless of the shape of the road. For example, as shown in the graph 405 of FIG. 4, the determination position will be set, regardless of the curvature of the road, at a fixed position which is apart from the vehicle 1 by a predetermined distance. The series of processes of FIG. 5 has been described above.

As described above, according to this embodiment, in a case in which the shape of the road in the direction of travel of the vehicle is not a curve, the lane departure suppression control is executed based on the determination position in the direction of travel of the vehicle, and in a case in which the shape of the road is a curve, the lane departure suppression control is executed based on the second determination position which is closer to the vehicle than the first determination position. As a result, it is possible to execute, based on a determination position suitable for the shape of the road, the lane departure suppression control to suppress the departure of the self-vehicle from the division line.

In addition, according to this embodiment, in a case in which the road ahead has a curved shape that will decrease the recognition accuracy, it is possible to perform a determination operation with better accuracy by executing the determination operation of the lane departure suppression control at a position (with higher recognition accuracy) closer to the self-vehicle in the direction of travel.

Also, since the determination is performed at a position closer to the self-vehicle than a case in which the shape of the road is not a curve, the determination position will be set at a position away from the division line. Hence, the lane departure suppression control will not be executed excessively when the self-vehicle is traveling on the curve, and travel control according to the intention of the occupant can be performed when the self-vehicle is traveling on the curve.

Furthermore, according to this embodiment, the determination position with respect to the road boundary will be set as a fixed position regardless of the shape of the road. By setting so that the lane departure suppression control will be preferably executed at an early timing even if the recognition accuracy will be degraded more or less, it becomes possible to prevent the vehicle from getting too close to the road boundary.

[Modification]

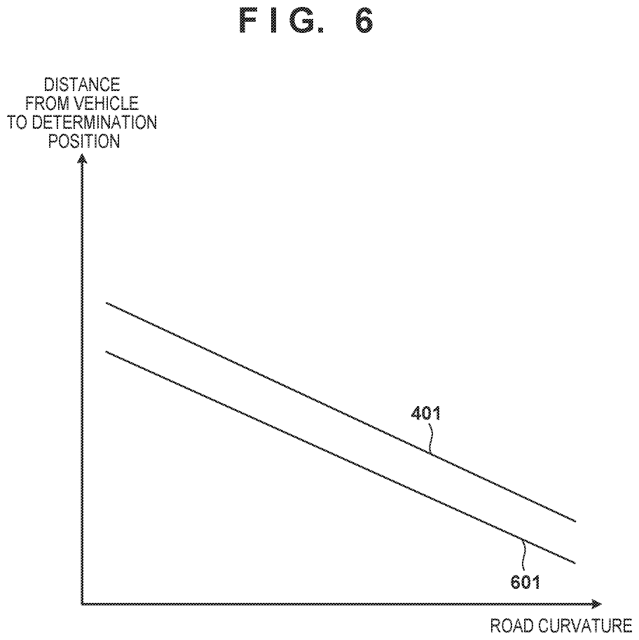

Although the above embodiment has described an example in which the determination position for executing the lane departure suppression control is changed based on the shape of the road, the determination position may also be changed by further considering the road width. For example, in a case in which the road width is a predetermined width or less, the lane departure suppression control may be executed too early if the determination position is set at a position far from the vehicle 1, and the self-vehicle may become too close to the center line (for example, the second division line 202) as a result. Hence, the ECU 20 will calculate the road width based on the information of the detected division line. In a case in which the road width is a predetermined width or less, a determination position that corresponds to the curvature of the road can be set, for example, in the manner of a graph 601 of FIG. 6, at a position closer to the vehicle 1 than that in the graph 401. That is, the ECU 20 may make settings so that the determination position P1 and the determination position P2 of a case in which the road width is a predetermined width or less will be arranged at positions closer to the vehicle 1 than the determination position P1 and the determination position P2 of a case in which the road width exceeds the predetermined width.

As a result, since positions closer to the vehicle 1 will be used as references as a whole, the vehicle 1 will be permitted to get closer to the first division line 201, and it becomes possible to prevent the vehicle 1 from getting too close to the center line while implementing the lane departure suppression control suitable for the shape of the road.

In addition, although the above embodiment described an example in which the determination position for executing the lane departure suppression control is changed based on the shape of the road, the determination position may be further changed in consideration of the presence/absence of an oncoming vehicle. Even in a case in which an oncoming vehicle is present, it is preferable to prevent, in a similar manner, the vehicle 1 from getting too close to the center line. Hence, in a similar manner to the case of the road width, the ECU 20 will determine the presence/absence of an oncoming vehicle. If the oncoming vehicle is present, the determination position corresponding to the curvature of the road can be set, for example, in the manner shown in the graph 601 of FIG. 6, at a position closer to the vehicle 1 than that of the graph 401. That is, it may be arranged so that the ECUs 22 and 23 will detect the oncoming vehicle, and the ECU 20 will set the determination position P1 and the determination position P2 of a case in which the oncoming vehicle is detected to be at positions closer to the vehicle 1 than the determination position P1 and the determination position P2 of a case in which the oncoming vehicle is not detected.

As a result, since positions closer to the vehicle 1 will be used as references as a whole, the vehicle 1 will be permitted to get closer to the first division line 201, and it becomes possible to prevent the vehicle 1 from getting too close to the center line (the oncoming vehicle) while implementing the lane departure suppression control suitable for the shape of the road.

Alternatively, in a case in which the road width is a predetermined width or less and an oncoming vehicle is present, the determination position may be set in accordance with the graph 601.

Although the above embodiment has described an example in which the division line and the road boundary are detected, and suitable lane departure suppression control is executed with respect to each of the division line and the road boundary, the lane departure suppression control according to this embodiment may be executed with respect to only the division line or the lane departure suppression control according to this embodiment may be executed with respect to only the road boundary.

According to the present invention, lane departure suppression control suitable for the shape of the road can be implemented.

### Other Embodiments

A program for implementing each function of one or more driving support apparatuses described in the embodiments is supplied to a system or apparatus via a network or storage medium, and one or more processors in the computer of the system or apparatus can read out and execute the program. This form can also implement the present invention.

### Summary of Embodiment

1. A vehicle control apparatus according to the above-described embodiment is a vehicle control apparatus that controls a vehicle (for example, 1), comprising:

a detector (for example, 20, 22, 23, 41, 42, 43) configured to detect at least one of a division line (for example, 201) and a road boundary (for example, 204) of a road;

a shape detector (for example, 20, 41, 42, 43) configured to detect a shape of the road; and

a controller (for example, 20) configured to execute, based on a determination position (for example, P1, P2, P3, P4) in a direction of travel of the vehicle, lane departure suppression control to suppress the vehicle from departing from at least one of the division line and the road boundary,

wherein

in a case in which the shape of the road in the direction of travel of the vehicle is not a curve, the controller executes the lane departure suppression control based on a first determination position (for example, P1, P3) in the direction of travel of the vehicle, and

in a case in which the shape of the road in the direction of travel of the vehicle is the curve, the controller executes the lane departure suppression control based on a second determination position (for example, P2, P4) closer to the vehicle than the first determination position.

According to this embodiment, lane departure suppression control suitable for the shape of the road can be implemented. Hence, it is possible to implement lane departure suppression control in accordance with the intention of the occupant.

2. In the vehicle control apparatus according to the above-described embodiment, the second determination position (for example, P2, P4) is a position (for example, 401-404, 406) that is increasingly closer to the vehicle as a curvature of the curve of the road increases.

According to this embodiment, lane departure suppression control more suitable for the shape of the road can be executed.

3. In the vehicle control apparatus according to the above-described embodiment, the determination position (for example, P1, P2, P3, P4) is a reference position for determining a lateral distance (for example, 301, 302, 303, 304) which is a distance in a road width direction with respect to one of the division line and the road boundary.

According to this embodiment, lane departure suppression control can be executed based on the distance from the division line to the determination position. For example, in a case in which the distance is equal to or less than a threshold, a lane departure suppression control function can be operated.

4. In the vehicle control apparatus according to the above-described embodiment, in the lane departure suppression control with respect to the division line, the controller changes the determination position (for example, P1, P2) in accordance with the shape of the road, and

in the lane departure suppression control with respect to the road boundary, the controller does not change, regardless of the shape of the road, the determination position (for example, P3) and maintains the determination position at a fixed position which is apart from the vehicle by a predetermined distance.

According to this embodiment, it is possible to prevent the vehicle from getting too close to the road boundary.

5. In the vehicle control apparatus according to the above-described embodiment, the controller calculates a road width based on the division line, and

the controller sets the first determination position (for example, P1, P3) and the second determination position (for example, P2, P4) of a case in which the road width is not more than a predetermined width to be set to positions closer to the vehicle than the first determination position and the second determination position of a case in which the road width is more than the predetermined width.

According to this embodiment, it is possible to implement the lane departure suppression control suitable for the shape of the road while preventing the vehicle from getting too close to the center line when the road width is narrow.

6. The vehicle control apparatus according to the above-described embodiment further comprises

an oncoming vehicle detector (for example, 22, 23) configured to detect an oncoming vehicle, and

the controller sets the first determination position (for example, P1, P3) and the second determination position (for example, P2, P4) of a case in which the oncoming vehicle is detected to be set to positions closer to the vehicle than the first determination position and the second determination position of a case in which the oncoming vehicle is not detected.

According to this embodiment, it is possible to implement the lane departure suppression control suitable for the shape of the road while preventing the vehicle from getting too close to the center line (an oncoming vehicle) when the oncoming vehicle is present.

7. A vehicle (for example, 1) according to the above-described embodiment is a vehicle comprising a vehicle control apparatus according to the above-described embodiment.

According to this embodiment, the processing executed by the vehicle control apparatus can be implemented in a vehicle.

8. An operation method of a vehicle control apparatus according to the above-described embodiment is an operation method of a vehicle control apparatus that controls a vehicle (for example, 1), the method comprising

detecting (for example, S501) at least one of a division line (for example, 201) and a road boundary of a road;

detecting (for example, S503) a shape of the road; and

executing (for example, S504), based on a determination position (for example, P1, P2) in a direction of travel of the vehicle, lane departure suppression control to suppress the vehicle from departing from at least one of the division line and the road boundary,

wherein in the executing,

in a case in which the shape of the road in the direction of travel of the vehicle is not a curve, the lane departure suppression control is executed based on a first determination position (for example, P1) in the direction of travel of the vehicle, and

in a case in which the shape of the road in the direction of travel of the vehicle is the curve, the lane departure suppression control is executed based on a second determination position (for example, P2) closer to the vehicle than the first determination position.

According to this embodiment, lane departure suppression control suitable for the shape of the road can be implemented. Hence, it is possible to implement lane departure suppression control in accordance with the intention of the occupant.

9. A program according to the above-described embodiment is a program for causing a computer to function as a vehicle control apparatus according to the above-described embodiment.

According to this embodiment, the contents of the present invention can be implemented by a computer.

The invention is not limited to the foregoing embodiments, and various variations/changes are possible within the spirit of the invention.

What is claimed is:

1. A vehicle control apparatus that controls a vehicle, comprising:
a detector configured to detect at least one of a division line and a road boundary of a road;
a shape detector configured to detect a shape of the road; and
a controller configured to execute, based on a determination position in a direction of travel of the vehicle, lane departure suppression control to suppress the vehicle from departing from at least one of the division line and the road boundary,
wherein
in a case in which the shape of the road in the direction of travel of the vehicle is not a curve, the controller executes the lane departure suppression control based on a first determination position in the direction of travel of the vehicle, and
in a case in which the shape of the road in the direction of travel of the vehicle is the curve, the controller executes the lane departure suppression control based on a second determination position closer to the vehicle than the first determination position.

2. The apparatus according to claim 1, wherein the second determination position is a position that is increasingly closer to the vehicle as a curvature of the curve of the road increases.

3. The apparatus according to claim 1, wherein the determination position is a reference position for determining a lateral distance which is a distance in a road width direction with respect to one of the division line and the road boundary.

4. The apparatus according to claim 1, wherein in the lane departure suppression control with respect to the division line, the controller changes the determination position in accordance with the shape of the road, and
in the lane departure suppression control with respect to the road boundary, the controller does not change, regardless of the shape of the road, the determination position and maintains the determination position at a fixed position which is apart from the vehicle by a predetermined distance.

5. The apparatus according to claim 1, wherein the controller calculates a road width based on the division line, and
the controller sets the first determination position and the second determination position of a case in which the road width is not more than a predetermined width to be set to positions closer to the vehicle than the first determination position and the second determination position of a case in which the road width is more than the predetermined width.

6. The apparatus according to claim 1, further comprising:
an oncoming vehicle detector configured to detect an oncoming vehicle,
wherein the controller sets the first determination position and the second determination position of a case in which the oncoming vehicle is detected to be set to positions closer to the vehicle than the first determination position and the second determination position of a case in which the oncoming vehicle is not detected.

7. A vehicle comprising a vehicle control apparatus defined in claim 1.

8. An operation method of a vehicle control apparatus that controls a vehicle, the method comprising:
detecting at least one of a division line and a road boundary of a road;
detecting a shape of the road; and
executing, based on a determination position in a direction of travel of the vehicle, lane departure suppression control to suppress the vehicle from departing from at least one of the division line and the road boundary,
wherein in the executing,
in a case in which the shape of the road in the direction of travel of the vehicle is not a curve, the lane departure suppression control is executed based on a first determination position in the direction of travel of the vehicle, and
in a case in which the shape of the road in the direction of travel of the vehicle is the curve, the lane departure suppression control is executed based on a second determination position closer to the vehicle than the first determination position.

9. A non-transitory computer-readable storage medium storing a program for causing a computer to execute an operation method of a vehicle control apparatus that controls a vehicle, the method comprising:
detecting at least one of a division line and a road boundary of a road;
detecting a shape of the road; and
executing, based on a determination position in a direction of travel of the vehicle, lane departure suppression control to suppress the vehicle from departing from at least one of the division line and the road boundary,
wherein in the executing,
in a case in which the shape of the road in the direction of travel of the vehicle is not a curve, the lane departure suppression control is executed based on a first determination position in the direction of travel of the vehicle, and
in a case in which the shape of the road in the direction of travel of the vehicle is the curve, the lane departure suppression control is executed based on a second determination position closer to the vehicle than the first determination position.
